(19) United States
(12) Patent Application Publication
(10) Pub. No.: US 2018/0014372 A1
(43) Pub. Date: Jan. 11, 2018

(54) LIGHT EMITTING DEVICE AND METHOD FOR DRIVING LIGHT EMISSION

(71) Applicant: Taiwan Green Point Enterprises Co., Ltd., Taichung City (TW)

(72) Inventors: Chia-Tai CHEN, Taichung City (TW); Sheng-Hung YI, Taichung City (TW); Pen-Yi LIAO, Taichung City (TW)

(73) Assignee: Taiwan Green Point Enterprises Co., Ltd., Taichung City (TW)

(21) Appl. No.: 15/639,313

(22) Filed: Jun. 30, 2017

(30) Foreign Application Priority Data
Jul. 6, 2016 (TW) 105121322

(51) Int. Cl. H05B 33/08; H05B 33/06

(52) U.S. Cl. CPC H05B 33/0842; H05B 33/06

(57) ABSTRACT

A method is described for driving light emission of a light emitting device that includes first and second electrode layers, and first and second groups of light emitting diodes between the first and second electrode layers. A first electrode voltage is provided to the first and second electrode layers to conduct the first group of light emitting diodes, and then a second electrode voltage is provided to the first and second electrode layers to conduct the second group of light emitting diodes.

### CROSS REFERENCE TO RELATED APPLICATION

This application claims priority of Taiwanese Patent Application No. 105121322, filed on Jul. 6, 2016.

### FIELD OF INVENTION

The disclosure relates to a light emitting device, and more particularly to a light emitting device with micro light emitting diode (micro-LED/μLED) chips.

### BACKGROUND

Compared to conventional light emitting technologies (e.g., liquid crystal display), micro-LED is advantageous in its self-emissive property, low optical loss, and high luminance, and is thus expected to solve the problem of low battery life in portable electronic devices, which may result from high power consumption of displays thereof.

In a printing process for manufacturing micro-LEDs, LED wafers are cut into micro-LED chips, followed by forming semiconductor ink with the micro-LED chips mixed therein, and then a printer device may be used to perform layout of the semiconductor ink on a substrate by, for example, screen printing or inkjet printing, resulting in advantages of low equipment cost compared to conventional packaging process, and being applicable to flexible displays. However, since the orientations of the micro-LED chips disposed on the substrate by such process would be random and irregular, it would hardly be possible to make all of the micro-LED chips conduct in practice, leading to low utilization rate of the micro-LED chips.

### SUMMARY

According to the disclosure, a method for driving light emission of a light emitting device which may alleviate at least one drawback of the prior art includes: providing a light emitting device which includes a plurality of electrode layers that include a first electrode layer and a second electrode layer, and a plurality of light emitting diodes that are disposed between the first and second electrode layers, wherein each of the light emitting diodes has an anode and a cathode, the light emitting diodes include a first group of light emitting diodes and a second group of light emitting diodes, and a voltage resulting from an AC driving voltage signal across the anode and the cathode of each of the light emitting diodes in the first group has a polarity opposite to that of a voltage resulting from the AC driving voltage signal across the anode and the cathode of each of the light emitting diodes in the second group; providing, to the first and second electrode layers, a first electrode voltage signal across the first and second electrode layers to form, between the first and second electrode layers, a first driving voltage signal in such a way that the light emitting diodes in the first group conduct; and providing, to the first and second electrode layers after the provision of the first electrode voltage signal ends, a second electrode voltage signal across the first and second electrode layers to form, between the first and second electrode layers, a second driving voltage signal in such a way that the light emitting diodes in the second group conduct.

According to the disclosure, a light emitting device which may alleviate at least one drawback of the prior art includes a plurality of electrode layers which include a first electrode layer and a second electrode layer, and a plurality of light emitting diodes disposed between the first and second electrode layers. The first electrode layer and the second electrode layer are disposed to receive an AC electrode voltage signal thereacross to form an AC driving voltage signal having a magnitude proportional to that of the AC electrode voltage signal therebetween. Each of the light emitting diodes has an anode and a cathode. The light emitting diodes includes a first group of light emitting diodes and a second group of light emitting diodes. A voltage resulting from the AC driving voltage signal across the anode and the cathode of each of the light emitting diodes in the first group has a polarity opposite to that of a voltage resulting from the AC driving voltage signal across the anode and the cathode of each of the light emitting diodes in the second group. The AC electrode voltage signal is provided in such a way that the light emitting diodes in the first group conduct in positive half-cycles of the AC electrode voltage signal, and that the light emitting diodes in the second group conduct in negative half-cycles of the AC electrode voltage signal.

According to the disclosure, a method for driving light emission of a light emitting device is proposed. The light emitting device includes a plurality of electrode layers which include a first electrode layer and a second electrode layer, a plurality of light emitting diodes disposed between the first and second electrode layers, and an AC voltage generator coupled to the first and second electrode layers. The first electrode layer and the second electrode layer are disposed to receive an AC electrode voltage signal thereacross to form an AC driving voltage signal having a magnitude proportional to that of the AC electrode voltage signal therebetween. Each of the light emitting diodes has an anode and a cathode. The light emitting diodes includes a first group of light emitting diodes and a second group of light emitting diodes. A voltage resulting from the AC driving voltage signal across the anode and the cathode of each of the light emitting diodes in the first group has a polarity opposite to that of a voltage resulting from the AC driving voltage signal across the anode and the cathode of each of the light emitting diodes in the second group. The method includes: by the AC voltage generator, generating an AC electrode voltage signal and providing the AC electrode voltage signal to the first and second electrode layers to form an AC driving voltage signal having a magnitude proportional to that of the AC electrode voltage signal therebetween. The AC electrode voltage signal is a periodic signal that has a waveform alternating between a positive half-cycle state and a negative half-cycle state at a predetermined frequency.

According to the disclosure, a lighting method which may alleviate at least one drawback of the prior art includes: disposing a first group of micro light emitting diodes and a second group of micro light emitting diodes between at least two electrode layers; and providing an AC electrode voltage signal to the at least two electrode layers to drive light emission by the first group of micro light emitting diodes in positive half-cycles of the AC electrode voltage signal, and drive light emission by the second group of micro light emitting diodes in negative half-cycles of the AC electrode voltage signal.

According to the disclosure, a lighting method which may alleviate at least one drawback of the prior art includes: disposing a plurality of first light emitting diodes and a plurality of second light emitting diodes between at least two electrode layers, wherein each of the first and second light emitting diodes has a cathode and an anode that are disposed at opposite ends thereof; and providing an AC electrode voltage signal to the at least two electrode layers to conduct the first light emitting diodes in positive half-cycles of the AC electrode voltage signal, and conduct the second light emitting diodes in negative half-cycles of the AC electrode voltage signal.

According to the disclosure, a lighting method which may alleviate at least one drawback of the prior art includes: randomly disposing a plurality of micro light emitting diodes each having a cathode and an anode such that the micro light emitting diodes include a first group of micro light emitting diodes and a second group of micro light emitting diodes, the cathodes and the anodes of the micro light emitting diodes of the second group having orientations different from orientations of the cathode and the anode of the micro light emitting diodes of the first group; and providing an AC voltage signal to the micro light emitting diodes in such a manner as to conduct the first group of micro light emitting diodes in positive half-cycles of the AC voltage signal, and conduct the second group of micro light emitting diodes in negative half-cycles of the AC voltage signal.

### BRIEF DESCRIPTION OF THE DRAWINGS

Other features and advantages of the disclosure will become apparent in the following detailed description of the embodiment(s) with reference to the accompanying drawings, of which:

FIG. 1 is a schematic diagram illustrating a first embodiment of a light emitting device according to the disclosure;

FIG. 2 is a schematic diagram illustrating a structure of a light emitting diode of the first embodiment;

FIG. 3 is a schematic circuit diagram illustrating an implementation of an AC voltage generator of the first embodiment;

FIG. 4 is a schematic circuit diagram illustrating another implementation of an AC voltage generator of the first embodiment; and

FIG. 5 is a schematic diagram illustrating a second embodiment of a light emitting device according to the disclosure.

### DETAILED DESCRIPTION OF THE PREFERRED EMBODIMENTS

Before the disclosure is described in greater detail, it should be noted that where considered appropriate, reference numerals or terminal portions of reference numerals have been repeated among the figures to indicate corresponding or analogous elements, which may optionally have similar characteristics.

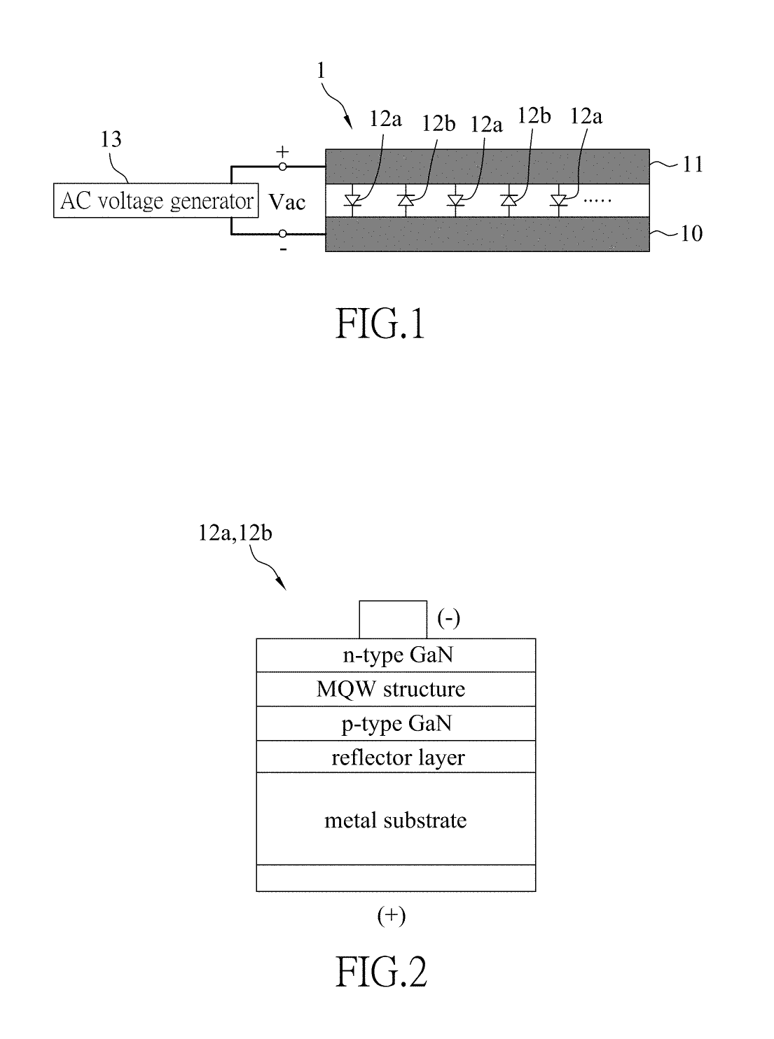

Referring to FIG. 1, a first embodiment of the light emitting device 1 according to this disclosure is shown to include a first electrode layer 10, a second electrode layer 11, a first group of light emitting diodes 12a, a second group of light emitting diodes 12b, and an alternating current (AC) voltage generator 13 that is coupled to the electrode layers 10, 11 and that generates an AC electrode voltage signal (Vac) across the first and second electrode layers 10, 11 for providing an AC driving voltage signal whose magnitude is proportional to that of the AC electrode voltage (Vac) between the electrode layers 10, 11. In this embodiment, the AC electrode voltage signal (Vac) is a periodic signal that has a waveform alternating between a positive half-cycle state and a negative half-cycle state at a predetermined frequency.

The light emitting diodes 12a, 12b are arranged between the first and second electrode layers 10, 11 by for example, but not limited to, screen printing, inkjet printing, etc. Referring to FIG. 2, in this embodiment, each light emitting diode 12a, 12b is a micro-LED chip with a dimension (e.g., a length of a longest side when the chip is shaped as a square or a rectangle from the perspective of a top view) smaller than 10 μm, and is a vertical light emitting diode having a cathode (−), an n-type GaN layer, a multiple-quantum-well (MQW) structure, a p-type GaN layer, a reflector layer, a metal substrate and an anode (+) that are stacked in the given order, where the metal substrate may be either a hard printed circuit board or a flexible printed circuit board, and this disclosure is not limited thereto.

In this embodiment, due to use of the printing electronics manufacturing process, the micro-LED chips are disposed between the electrode layers 10, 11 in a random manner, and orientations of the same thus vary (i.e., the anodes and the cathodes of the micro-LED chips may face towards different directions). In this embodiment, the light emitting diodes 12a of the first group refers to the micro-LED chips having the cathode (−) and anode (+) respectively coupled to the first and second electrode layers 10, 11, and the light emitting diodes 12b of the second group refers to the micro-LED chips having the anode (+) and cathode (−) respectively coupled to the first and second electrode layers 10, 11. There may still be other micro-LED chips which may be laterally disposed such that at least one of the cathode (−) and the anode (+) thereof is not coupled to either one of the first and second electrode layers 10, 11 (not shown).

In this embodiment, the AC voltage generator 13 is an inverter, such as a half bridge inverter or a full bridge inverter, but this disclosure is not limited thereto.

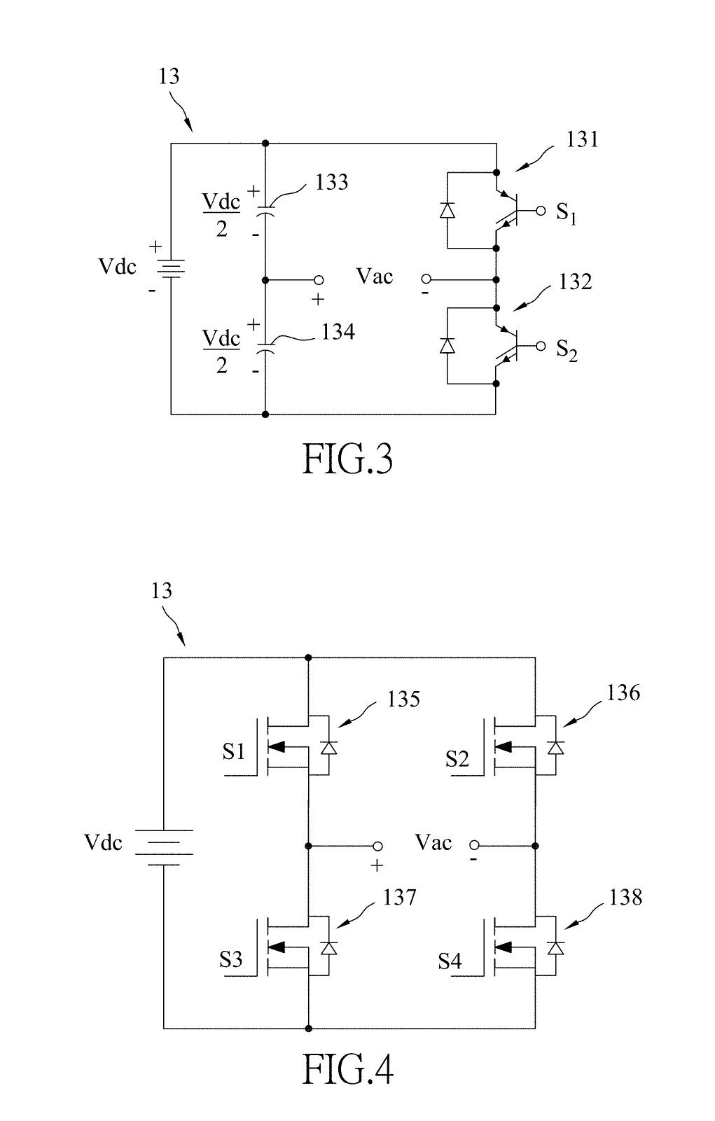

In FIG. 3, the AC voltage generator 13 is a half bridge inverter which receives a direct current (DC) voltage (Vdc), and includes series-connected switches 131, 132 that respectively receive control signals (S1, S2) to alternately conduct, and series-connected capacitors 133, 134 that are coupled to the series-connected switches 131, 132 in parallel, so as to convert the DC voltage (Vdc) into the AC electrode voltage signal (Vac).

In FIG. 4, the AC voltage generator 13 is a full bridge inverter which receives a direct current (DC) voltage (Vdc), and includes a pair of series-connected switches 135, 137 that respectively receive control signals (S1, S3), and a pair of series-connected switches 136, 138 that are coupled to the series-connected switches 135, 137 in parallel and that respectively receive control signals (S2, S4) to convert the DC voltage (Vdc) into the AC electrode voltage signal (Vac).

The AC voltage generator 13 generates the AC electrode voltage signal (Vac) across the electrode layers 10, 11 with the predetermined frequency of, for example but not limited to, between 400 Hz and 1000 Hz. The AC driving voltage signal has a peak voltage of which an absolute value is greater than a threshold voltage of the micro-LED chips, such that the light emitting diodes 12a of the first group conduct (i.e., in a forward bias state where a voltage between the anode and the cathode is positive) and the light emitting diodes 12b of the second group do not conduct (i.e., in a reverse bias state where the voltage between the anode and the cathode is negative) in positive half-cycles of the AC electrode voltage signal (Vac), and the light emitting diodes 12b of the second group conduct and the light emitting diodes 12a of the first group do not conduct in negative half-cycles of the AC electrode voltage signal (Vac). As a result, the light emitting diodes 12a of the first group emit light in the positive half-cycles of the AC electrode voltage signal (Vac), and the light emitting diodes 12b of the second group emit light in the negative half-cycles of the AC electrode voltage signal (Vac), with the first and second groups alternating in the light emission, resulting in a relatively higher utilization rate of the micro-LED chips, and subjectively, higher perception of brightness to the user. It should be noted that, since the predetermined frequency is set to be much higher than that detectable by human eyes, users may not be aware of the alternate light emission of the first and second groups of the light emitting diodes 12a, 12b.

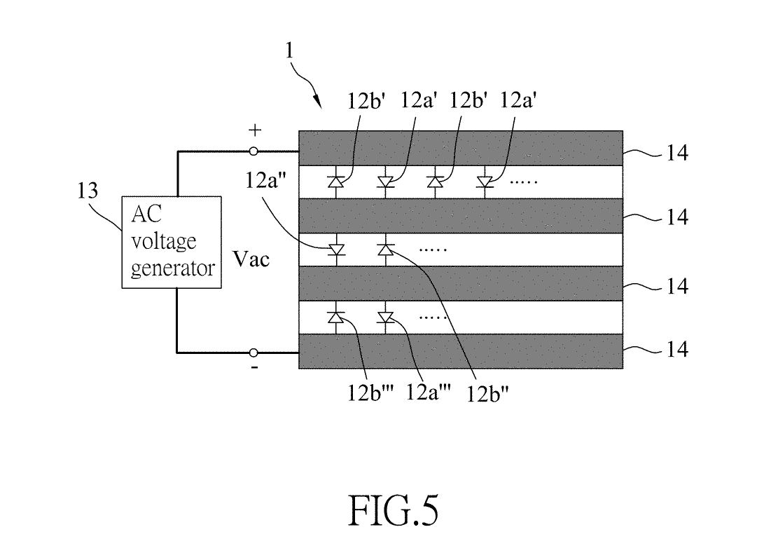

Referring to FIG. 5, a second embodiment of the light emitting device 1 according to this disclosure is shown to include more than two electrode layers 14, a group of light emitting diodes 12a′ and a group of light emitting diodes 12b′ between first and second ones of the electrode layers 14, a group of light emitting diodes 12a″ (only one is shown) and a group of light emitting diodes 12b″ (only one is shown) between second and third ones of the electrode layers 14, a group of light emitting diodes 12a′″ (only one is shown) and a group of light emitting diodes 12b′″ (only one is shown) between third and fourth ones of the electrode layers 14, and an AC voltage generator 13 that is coupled to two of the electrode layers 14 and that generates an AC electrode voltage signal (Vac) across the two electrode layers 14 for providing an AC driving voltage signal whose magnitude is proportional to that of the AC electrode voltage signal (Vac) between the two electrode layers 14 to which the AC voltage generator 13 is coupled. In this embodiment, the AC voltage generator 13 is coupled to the first (top) and fourth (bottom) electrode layers 14 to provide the AC electrode voltage signal (Vac) thereacross. The AC driving voltage signal has a peak voltage of which an absolute value is greater than three times the threshold voltage of the micro-LED chips, such that paths formed by the light emitting diodes 12a′, 12a″, 12a′″ conduct in positive half-cycles of the AC electrode voltage signal (Vac), and the light emitting diodes 12b′, 12b″, 12b′″ conduct in negative half-cycles of the AC electrode voltage signal (Vac). As a result, in the positive half-cycles of the AC electrode voltage signal (Vac), the light emitting diodes 12a′, 12a″, 12a′″ emit light, and in the negative half-cycles of the AC electrode voltage (Vac), the light emitting diodes 12b′, 12b″, 12b′″ emit light, achieving the same effect as the first embodiment.

In summary, by virtue of providing the AC electrode voltage signal (Vac) to the electrode layers of the light emitting device 1, two groups of the micro-LED chips may alternately emit light at a predetermined high frequency, resulting in a relatively higher utilization rate of the micro-LED chips while the light flickering is unnoticeable by the users.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for driving light emission of a light emitting device, comprising:
providing a light emitting device which includes a plurality of electrode layers that include a first electrode layer and a second electrode layer, and a plurality of light emitting diodes that are disposed between the first and second electrode layers, each of the light emitting diodes having an anode and a cathode, the light emitting diodes including a first group of light emitting diodes and a second group of light emitting diodes, a voltage resulting from an alternating current (AC) driving voltage signal across the anode and the cathode of each of the light emitting diodes in the first group having a polarity opposite to that of a voltage resulting from the AC driving voltage signal across the anode and the cathode of each of the light emitting diodes in the second group;
providing, to the first and second electrode layers, a first electrode voltage signal across the first and second electrode layers to form, between the first and second electrode layers, a first driving voltage signal that allows the light emitting diodes in the first group to conduct; and
providing, to the first and second electrode layers after the provision of the first electrode voltage signal ends, a second electrode voltage signal across the first and second electrode layers to form, between the first and second electrode layers, a second driving voltage signal that allows the light emitting diodes in the second group to conduct.

2. The method of claim 1, wherein the first and second electrode voltage signals cooperate to form an alternating current (AC) electrode voltage signal of which positive cycles correspond to the first electrode voltage signal and of which negative cycles correspond to the second electrode voltage signal, and wherein the first and second driving voltage signals cooperate to form the AC driving voltage signal which corresponds to the AC electrode voltage signal and which has a magnitude proportional to that of the AC electrode voltage signal.

3. The method of claim 2, wherein each of the light emitting diodes is a vertical light emitting diode.

4. The method of claim 2, wherein each of the light emitting diodes is a micro light emitting diode of which a dimension is smaller than 10 μm.

5. The method of claim 2, wherein the AC electrode voltage signal has a predetermined frequency of between 400 Hz and 1000 Hz.

6. The method of claim 2, wherein the light emitting device further includes more than two of the electrode layers, and the light emitting diodes are disposed between each adjacent pair of the electrode layers, and two of the electrode layers respectively serve as the first and second electrode layers to receive the AC electrode voltage signal.

7. A light emitting device comprising:
a plurality of electrode layers which include a first electrode layer and a second electrode layer, said first electrode layer and said second electrode layer being disposed to receive an alternating current (AC) electrode voltage signal thereacross to form an AC driving voltage signal having a magnitude proportional to that of the AC electrode voltage signal therebetween; and
a plurality of light emitting diodes disposed between said first and second electrode layers, each of said light emitting diodes having an anode and a cathode, said light emitting diodes including a first group of light emitting diodes and a second group of light emitting diodes, a voltage resulting from the AC driving voltage signal across said anode and said cathode of each of said light emitting diodes in said first group having a polarity opposite to that of a voltage resulting from the AC driving voltage signal across said anode and said cathode of each of said light emitting diodes in said second group,
wherein the AC electrode voltage signal allows said light emitting diodes in said first group to conduct in positive half-cycles of the AC electrode voltage signal, and that said light emitting diodes in said second group to conduct in negative half-cycles of the AC electrode voltage signal.

8. The light emitting device of claim 7, wherein each of said light emitting diodes is a vertical light emitting diode.

9. The light emitting device of claim 7, wherein each of said light emitting diodes is a micro light emitting diode of which a dimension is smaller than 10 μm.

10. The light emitting device of claim 7, wherein the AC electrode voltage signal has a predetermined frequency of between 400 Hz and 1000 Hz.

11. The light emitting device of claim 7, further comprising an AC voltage generator coupled to said first and second electrode layers, and configured to generate the AC electrode voltage and provide the AC electrode voltage to said first and second electrode layers.

12. A method for driving light emission of a light emitting device which includes:
a plurality of electrode layers which include a first electrode layer and a second electrode layer, the first electrode layer and the second electrode layer being disposed to receive an alternating current (AC) electrode voltage signal thereacross to form an AC driving voltage signal having a magnitude proportional to that of the AC electrode voltage signal therebetween;
a plurality of light emitting diodes disposed between the first and second electrode layers, each of the light emitting diodes having an anode and a cathode, the light emitting diodes including a first group of light emitting diodes and a second group of light emitting diodes, a voltage resulting from the AC driving voltage signal across the anode and the cathode of each of the light emitting diodes in the first group having a polarity opposite to that of a voltage resulting from the AC driving voltage signal across the anode and the cathode of each of the light emitting diodes in the second group; and
an AC voltage generator coupled to the first and second electrode layers;
said method comprising:
by the AC voltage generator, generating an alternating current (AC) electrode voltage signal and providing the AC electrode voltage signal to the first and second electrode layers to form an AC driving voltage signal having a magnitude proportional to that of the AC electrode voltage signal therebetween, wherein the AC electrode voltage signal is a periodic signal that has a waveform alternating between a positive half-cycle state and a negative half-cycle state at a predetermined frequency.

13. A lighting method comprising:
disposing a first group of micro light emitting diodes and a second group of micro light emitting diodes between at least two electrode layers; and
providing an alternating current (AC) electrode voltage signal to the at least two electrode layers to drive light emission by the first group of micro light emitting diodes in positive half-cycles of the AC electrode voltage signal, and drive light emission by the second group of micro light emitting diodes in negative half-cycles of the AC electrode voltage signal.

14. A lighting method comprising:
disposing a plurality of first light emitting diodes and a plurality of second light emitting diodes between at least two electrode layers, each of the first and second light emitting diodes having a cathode and an anode that are disposed at opposite ends thereof; and
providing an alternating current (AC) electrode voltage signal to the at least two electrode layers to conduct the first light emitting diodes in positive half-cycles of the AC electrode voltage signal, and conduct the second light emitting diodes in negative half-cycles of the AC electrode voltage signal.

15. A lighting method comprising:
randomly disposing a plurality of micro light emitting diodes each having a cathode and an anode, wherein the micro light emitting diodes includes a first group of micro light emitting diodes and a second group of micro light emitting diodes, the cathodes and the anodes of the micro light emitting diodes of the second group having orientations different from orientations of the cathode and the anode of the micro light emitting diodes of the first group; and
providing an alternating current (AC) voltage signal to the micro light emitting diodes to conduct the micro light emitting diodes of the first group in positive half-cycles of the AC voltage signal, and conduct the micro light emitting diodes of the second group in negative half-cycles of the AC voltage signal.
